(19) United States
(12) Patent Application Publication
(10) Pub. No.: US 2004/0049628 A1
(43) Pub. Date: Mar. 11, 2004

(54) Multi-tasking non-volatile memory subsystem

(76) Inventors: Fong-Long Lin, Fremont, CA (US); Mete Ugur, San Jose, CA (US); Simpson Tao, San Jose, CA (US); Dongshen Xing, Fremont, CA (US)

Correspondence Address: GRAY CARY WARE & FREIDENRICH LLP, 2000 UNIVERSITY AVENUE, E. PALO ALTO, CA, 94303-2248, US

(21) Appl. No.: 10/241,198

(22) Filed: Sep. 10, 2002

(51) Int. Cl. G06F 12/00

(52) U.S. Cl. 711/103; 711/202

(57) ABSTRACT

A non-volatile memory subsystem comprises a plurality of non-volatile memory integrated circuit chips. Each of the plurality of integrated circuit memory chips is capable of being read, erased or programmed. Each of the plurality of memory chips further has a data bus and an address bus. A controller chip is coupled to the plurality of memory chips and receives a plurality of externally supplied tasks to be executed by the plurality of memory chips. The controller chip further comprises a task scheduler for scheduling the simultaneous execution of the plurality of tasks by the plurality of memory chips and a status poll scheduler for polling each of the plurality of memory chips to determine when a memory chip has completed its task.

### TECHNICAL FIELD

The present invention relates to a non-volatile memory subsystem and more particularly to a subsystem in which the non-volatile memory comprises a plurality of conventional flash memory integrated circuit chips, with each memory chip capable of performing the tasks of read, erase or program with the memory subsystem capable of performing a plurality of tasks with the plurality of memory chips simultaneously.

This application incorporates by reference the files on a Compact Disc Recordable (CD-R) media, for operating under IBM-PC machine format and MS-Windows operating system. The files are for execution by a Sun workstation machine (Ultra SPARC model, operating under the Solaris operating system) made by Sun Microsystems Inc. of Santa Clara, Calif. The list of files contained on the CD-R media, including the names, sizes in bytes and dates of creation is as follows:

| Name | Size | Date of Creation |
|---|---|---|
| Addr_sm.v | 22 KB | Mar. 24, 1999 |
| cmd2dsa_wen.v | 1 KB | Jun. 23, 1999 |
| mda_interface.v | 83 KB | Aug. 7, 1999 |
| mda_sgnl.v | 78 KB | Aug. 9, 1999 |
| poll_stma.v | 24 KB | Aug. 9, 1999 |
| saddr_sm.v | 3 KB | Mar. 24, 1999 |
| samcmd_sm0.v | 9 KB | Sep. 28, 1999 |
| samcmd_sm1.v | 15 KB | Jul. 3, 1999 |
| samcmd_sm3.v | 17 KB | Sep. 19, 1999 |
| samcmd_sm7.v | 14 KB | Jul. 14, 1999 |
| samcmd_sm9.v | 3 KB | Mar. 24, 1999 |
| samcmd_smb.v | 13 KB | Jun. 21, 1999 |
| scmd_sm.v | 2 KB | Aug. 9, 1998 |
| sdma_sm.v | 14 KB | May 10, 1999 |
| syn_mrdy.v | 1 KB | Jul 11, 1999 |

### BACKGROUND OF THE INVENTION

Non-volatile memory integrated circuit chips are well known in the art. Typically, they have been used in a memory subsystem such as that of the Compactflash™ standard or the PCMCIA standard or the memory stick standard or the ATA disk module standard, in which a memory controller controls the operation of the flash memory integrated circuit chip. Heretofore, in order to expand the capacity and capability of the memory integrated circuit chip of such a subsystem, the memory chip has increased in density. This has been achieved by continually using a single integrated circuit chip (with increased density) but responsive to a single task.

However, the problem with a single memory integrated circuit chip being responsive to a single task is that performance suffers. In particular, since a chip is capable of performing the task of read, program or erase, when one of these tasks is performed on the chip, the chip is unable to perform other task and other task must be held in abeyance until the first task is finished. This has slowed the performance of such a system notwithstanding the increase in density. Thus, there is a need to increase the performance of such a memory subsystem, but at the same time maintain the density desired.

### SUMMARY OF THE INVENTION

A non-volatile memory subsystem comprises a plurality of non-volatile memory integrated circuit chips. Each of the plurality of integrated circuit memory chips is capable of being read, erased or programmed. Each of the plurality of memory chips further has a data bus and an address bus. A controller chip is coupled to the plurality of memory chips and receives a plurality of externally supplied tasks to be executed by the plurality of memory chips. The controller chip further comprises a task scheduler for scheduling the simultaneous execution of the plurality of tasks by the plurality of memory chips and a status poll scheduler for polling each of the plurality of memory chips to determine when a memory chip has completed its task.

### BRIEF DESCRIPTION OF THE DRAWINGS

FIG. 1 is a schematic block level diagram of one embodiment of the memory subsystem of the present invention.

FIG. 2 is a schematic block level diagram of another embodiment of the memory subsystem of the present invention.

FIG. 3 is a flow chart showing the steps of execution by the controller in the memory subsystem of the present invention of either embodiment shown in FIG. 1 or FIG. 2.

FIGS. 4A-4H is a timing diagram showing the simultaneous execution of two erase tasks, and two programming tasks with the apparatus shown in FIG. 1.

FIGS. 5A-5C is a timing diagram showing the simultaneous execution of four erase tasks with the embodiment of the present invention shown in FIG. 1.

FIGS. 6A-6E is a timing diagram showing the simultaneous execution of six program tasks with the embodiment of the present invention shown in FIG. 1.

FIG. 7 is a block level diagram showing the operation of the firmware executed by the controller in the embodiment of the present invention shown in either FIG. 1 or FIG. 2, wherein the multiple memory chips are polled for completion by the system hardware.

FIG. 8 is a block diagram of four integrated circuit memory chips having blocks grouped for execution of four tasks simultaneously.

FIG. 9 is a block level diagram showing four integrated circuit memory chips having blocks grouped for execution of two tasks simultaneously.

### DETAILED DESCRIPTION OF THE INVENTION

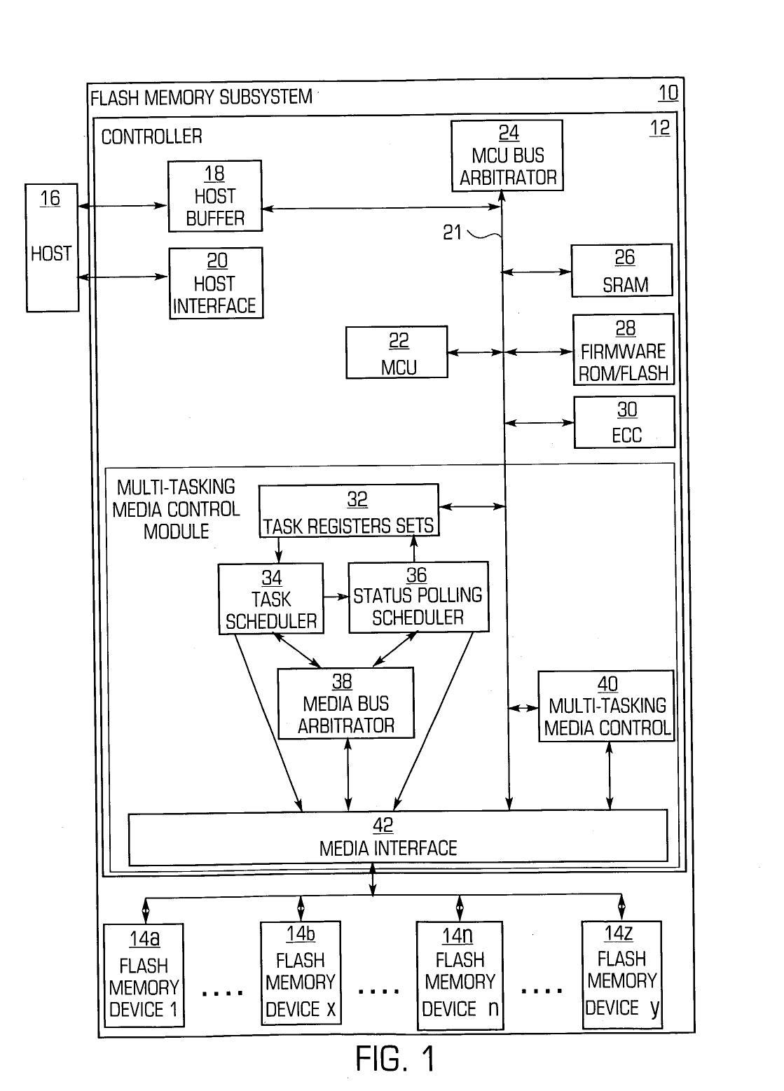

Referring to FIG. 1, there is shown a first embodiment of a flash memory subsystem 10 of the present invention. The subsystem 10 can be embodied in a standard format such as a PCMCIA format, or a Compactflash™ format, or a memory stick format, or a smart media format, or ATA disk module format. In addition, the subsystem 10 can be embodied in a non-standard format as well. Thus, the subsystem 10 may be used with an external host 16 such as a computer, an audiovisual player, a PDA, or any digital device that can interface with and use non-volatile flash for storage or retrieval.

The subsystem 10 comprises a controller 12. The controller 12 interfaces with the external host 16 through a host buffer 18, which stores digital data in way of digital signals which are either from the host 16 or destined for the host 16. In addition, the controller 12 comprises a host interface circuit 20. The controller 12 also comprises a microcontroller unit 22. In a preferred embodiment, the MCU 22 can be a well known microcontroller core of the 6502 type. The microcontroller unit 22 interfaces with the bus 21 to which the host buffer 18 also interfaces. The bus 21 is also connected to the MCU bus arbitrator 24. A volatile memory array 26, such as an SRAM 26 is also attached to the bus 21. A read only memory or flash memory 28 for storing firmware which is executed by the MCU 22 is also connected to the bus 21. Finally, an error correction unit 30 is attached to the bus 21.

The MCU 22 and bus 21 also interfaces with a multi-tasking media control module 23. Within the module 23 is a plurality of task register sets 32 which interfaces with the MCU 22 and the bus 21. The task register sets 32 stores a list of tasks that are to be executed. A task scheduler 34 receives the tasks that are stored in the plurality of task registers sets 32. A status polling scheduler 36 interfaces with the task registers sets 32 and with the task scheduler 34. Both the task scheduler 34 and the task polling scheduler 36 interface with a media bus arbitrator 38. The task scheduler 34, status polling scheduler 36 and the media bus arbitrator 38 interfaces with a media interface 42, to which the bus 21 also interfaces. Finally, a multi-tasking media control 40 circuit, interfaces with the bus 21 and with the media interface 42.

The subsystem 10 further comprises a plurality of flash memory integrated circuit chips 14A . . . 14Z. Each of the flash memory integrated circuit chips 14 is a conventional well known flash memory chip such as a NAND flash chip or a nor flash chip. Each has a chip enable pin, a WE/RE pin for write enable or read enable, and a data bus and an address bus. In the embodiment shown in FIG. 1, the plurality of memory integrated circuit chips 14A-14Z have all of the data buses connected together and to the media interface 42. In addition, all of the address buses of each of the flash memory chips 14A-14Z are connected together and to the media interface 42, with the data bus and the address bus being time multiplexed. In a preferred embodiment, each of the flash memory integrated circuit chips 14A-Z is a NAND flash chip comprising of 128 megabytes of storage with four NAND chips in total for a total storing capacity of 512 megabytes.

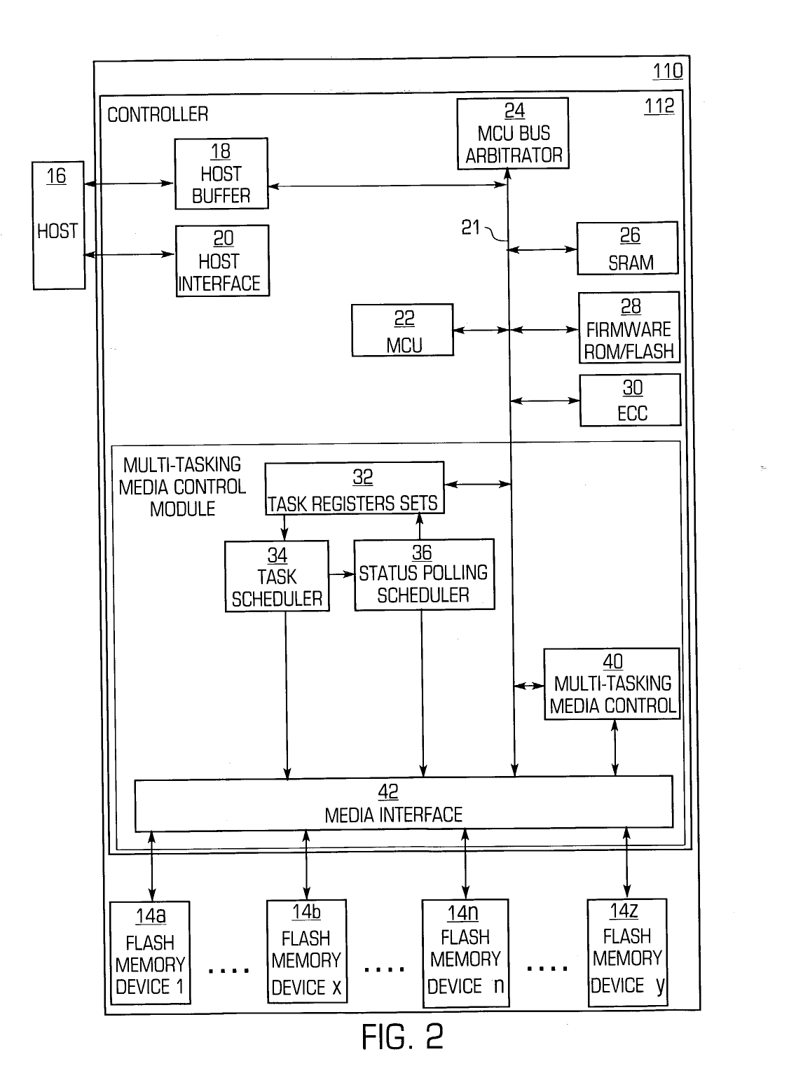

Referring to FIG. 2 there is shown a second embodiment of a flash memory subsystem 110 of the present invention. The flash memory subsystem 110 of the present invention is virtually identical to the flash memory subsystem 10 of the present invention shown in FIG. 1. Similar to the flash memory subsystem 10, the subsystem 110 comprises a controller 112 which interfaces with an external host 16 and receives a plurality of tasks therefrom. The controller 112 comprises the same elements of a host buffer 18, host interface 20, and a bus 21. The controller 112 also comprises an MCU bus arbitrator 24 and MCU 22, an SRAM 26, a firmware ROM/flash 28 and an ECC unit 30 all connected to the bus 21. The only difference between the controller 112 and the controller 12 is the difference in the multi-tasking media control module 123 of the subsystem 110. The module 123 comprises a task register set 32 which interfaces with a task scheduler 34 and a status polling scheduler 36. Both the task scheduler 34 and the status polling scheduler 36 interfaces with the media interface 42. They do not interface with the media bus arbitrator 38. Finally, the module 123 comprises a multi-tasking media control 40 interfacing with the media interface 42 and the bus 21. Thus, the multi-tasking media control module 123 is different from the module 23 in the absence of a media bus arbitrator 38.

The subsystem 110 also comprises a plurality of flash memory integrated circuit chips 14A-Z. Each of the flash memory chips 14 is identical to the flash memory chip 14 shown in FIG. 1. Thus, each of the flash memory integrated circuit chip 14 has a chip enable or CE control pin, a WE/RE pin or write enable/read enable, a data bus and an address bus. However, unlike the subsystem 10 shown in FIG. 1, each of the integrated circuit chips 14 has its data bus and its address bus connected directly to the media interface 42. Thus, there are a plurality of data buses and a plurality of address buses from the media interface 42 connecting to the plurality of integrated circuit memory chips 14 of FIG. 2.

In the preferred embodiment of the present invention, the apparatus 10 shown in FIG. 1 or the apparatus 110 shown in FIG. 2 is designed by using verilog code executed on a Sun Microsystems computer, which generates the circuit diagram for the invention. The invention is shown in block diagram form in FIGS. 1 and 2 for explanatory purposes. However, the apparatus 10 or 110 is not designed with those blocks separated. Further, in the implementation shown in the computer program listing on the attached CD Rom, whose files are incorporated by reference, the verilog code merely implements some of the functions described in and shown in FIGS. 1 and 2. It is the intent of the inventors that the invention includes the functions described in FIGS. 1 and 2 and that the invention can be implemented by verilog code.

In the subsystem 10 shown in FIG. 1 and the subsystem 110 shown in FIG. 2, the MCU 22 executes firmware stored in the ROM/flash 28. The MCU 22 executing the firmware stored in the ROM 28 causes commands that are received from the external host 16 to be converted into tasks and loaded into the task register sets 32. Each task registers 32 consists of a device select address register DSA_REG, a command register CMD_REG, a device address register ADDR_REG, a data size register SIZE_REG, a buffer address register BUFA_REG, and a status register STATUS_REG. The MCU 22 executes the firmware in the ROM/flash 28 to schedule the tasks by setting appropriate task registers and then move forward for other system tasks. The multi-tasking media control 40 along with the task scheduler 34 takes the information inside the task registers set 32 and carries out the operations. The hardware also updates status periodically. Upon completion of each task, result and status will be updated to the STATUS_REG and an interrupt is generated to the MCU 22 so that the firmware 28 is notified.

The device select address DSA in DSA_REG can be a physical or a logical flash memory device identification number. During power on initiation, each flash memory device 14 is associated with a DSA. A DSA will be translated by the media interface 42 to the CE number of the specific flash memory integrated circuit chip 14 during flash memory operation. The DSA designates a task to a specific integrated circuit memory chip 14.

The command in CMD_REG defines what kind of flash memory operation is for the task. The task can be read, erase, program, read status, move sector, read manufacturing I.D., etc. The definition of the command can be the same as the targeted flash integrated circuit memory chip 14 command, or can be translated by the media interface 42 to a command which is native to the flash integrated circuit memory chip 14.

The device address in ADDR_REG is the start address of the location, sector or block of a specific flash memory integrated circuit device 14 selected by DSA, for the task to be carried out.

The data size in SIZE_REG indicates what is the total length of data to be transferred. The unit of the size could be in bytes, a sector, or a block based on the flash architecture and operation particular to the flash integrated memory circuit chip 14.

The buffer address in BUFA_REG is the starting address of data buffer for the task scheduler 34 and multi-tasking media control 40 to either acquire data that is data to be written or to store data, i.e., data to be read, for the task or the flash operation.

Finally, the status in STATUS_REG provides the status of a task. The register has at least a ready/busy bit, a pass/fail bit, and an interrupt/pending bit. When the command register is written, the ready/busy bit will be cleared to indicate the task is busy. The status polling scheduler 36 updates the status register periodically. Upon completion of the task, the ready/busy bit will be set to indicate the completion of the task and other statuses will also be updated to indicate the execution result of the task. An interrupt would then be generated to the MCU 22 to inform the firmware 28 and the interrupt pending bit will be set. A read to status register will clear the status register. An alternate status register also provides for firmware polling without clearing the status register.

In operation, once the registers in the task registers sets 32 are set by the MCU 22 in accordance with the tasks to be performed, the task scheduler 34 begins the execution of those tasks. In the embodiment shown in FIG. 1, because there is only a single common bus (one bus common for both data and address, time multiplexed), the access to the bus (data or address) by the task scheduler 34 and status polling scheduler 36 must go through the media bus arbitrator 38. Once the tasks have been commenced for operation by the plurality of integrated circuit memory chips 14, the status polling schedule 36 polls each of the integrated circuit memory chips 14 to determine the status of the completion of the tasks assigned to each chip 14. When the status polling schedule 36, which also competes for the bus with the task scheduler 34, has determined that a particular task has been completed, then the task registers sets 32 are then appropriately cleared or reset. This notifies the MCU 22 that another task can now be assigned to the plurality of integrated circuit memory chips 14.

The only difference between the controller 12 of FIG. 1 and the controller 112 of FIG. 2 is the absence of the media bus arbitrator 38 and multiple sets of media buses, the operation of the subsystem 110 shown in FIG. 2 is virtually identical to the foregoing.

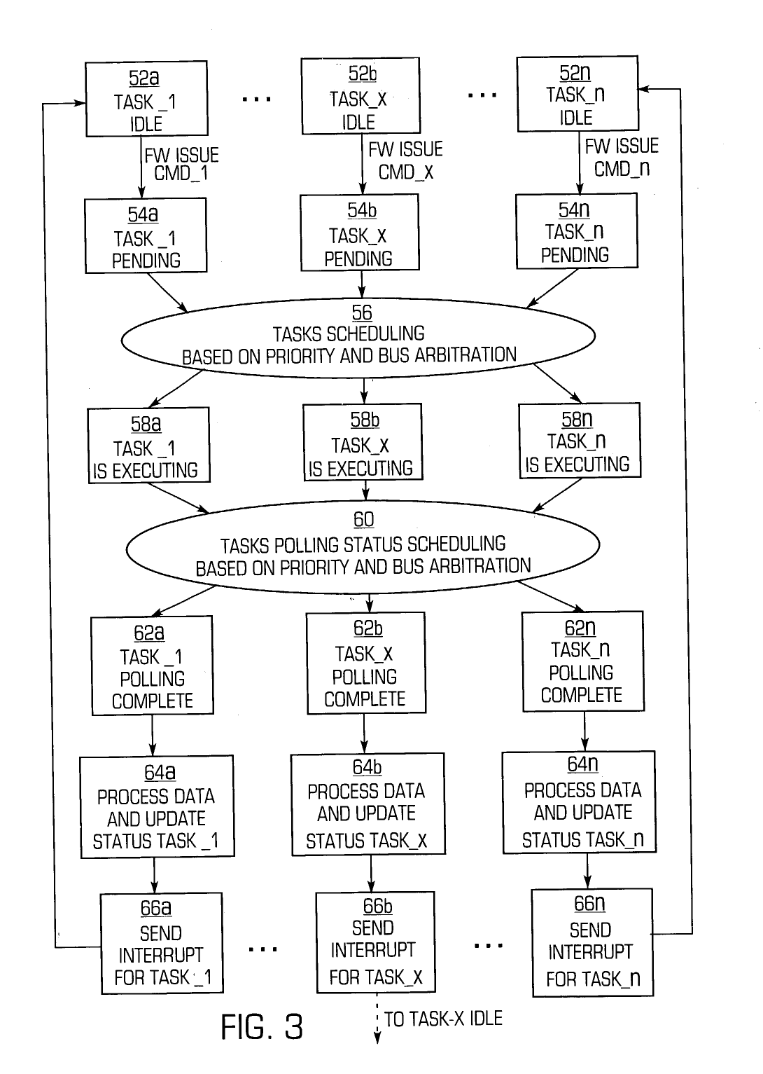

Referring to FIG. 3, there is shown a flow chart describing the operation of the flash memory subsystem 10 shown in FIG. 1. The task scheduler 34 performs task scheduling when there is a task pending, i.e., when the MCU 22 writes to the command registers of the task registers sets 32. The task scheduler 34 will schedule the tasks to start based upon certain algorithm. A round robin algorithm is one example that can be used. Other algorithms, such as first come-first served, or priority setting, or less recently used (LRU), or most recently used (MRU), may also be used. Because both the task scheduler 34 and the status polling scheduler 36 compete for the bus through the media bus arbitrator 38, the task scheduler 34 is given higher priority to start the tasks.

In the case of the subsystem 10, after a task has been selected to be started, the task scheduler 34 sends a request to the media bus arbitrator 38 for media bus usage to begin a task. The media bus arbitrator 38 will grant the request if the bus is not busy or if the media bus arbitrator 38 needs to arbitrate between the polling scheduler 36 and the task scheduler 34 for this request. After a task has been granted for media bus usage, the task scheduler 34 will direct the media interface 42 to start the task. The media interface 42 will issue flash memory bus cycles to start the flash memory task operation. Then the task will be assigned to the status polling stage.

In the subsystem 110 shown in FIG. 2, after a task has been selected to be started, the task scheduler 34 will direct media interface 42 to start the task. The media interface 42 will issue flash memory bus cycles to start the flash memory task operation. Then the task will be in a status polling stage.

In the polling stage, referring to FIG. 1, with the flash memory subsystem 10, the status polling scheduler 36 will schedule and request access to the media bus through the media bus arbitrator 38. An example of an algorithm used for polling scheduling is the round robin algorithm. After the media bus arbitrator 38 grants the media bus to the status polling scheduler 36, the status polling scheduler 36 directs the media interface 42 to issue status read command for the particular integrated memory circuit chip 14 which is executing the task in question. The status will then be updated to the corresponding task-status register. Upon the status polling scheduler 36 detecting the completion of a task, the multi-tasking media control 40 and the media interface 42 will perform the necessary operation to complete the task if needed, such as moving data to the buffer for the SRAM 26 in a read operation. The status and the result of that task will be updated in the status register and an interrupt to the MCU 22 is generated.

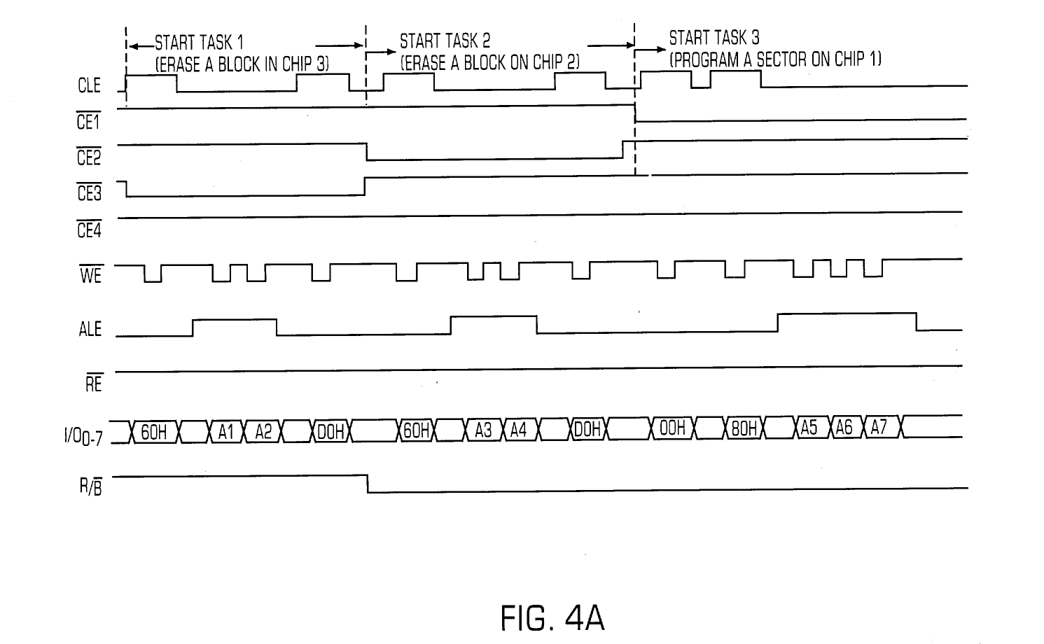

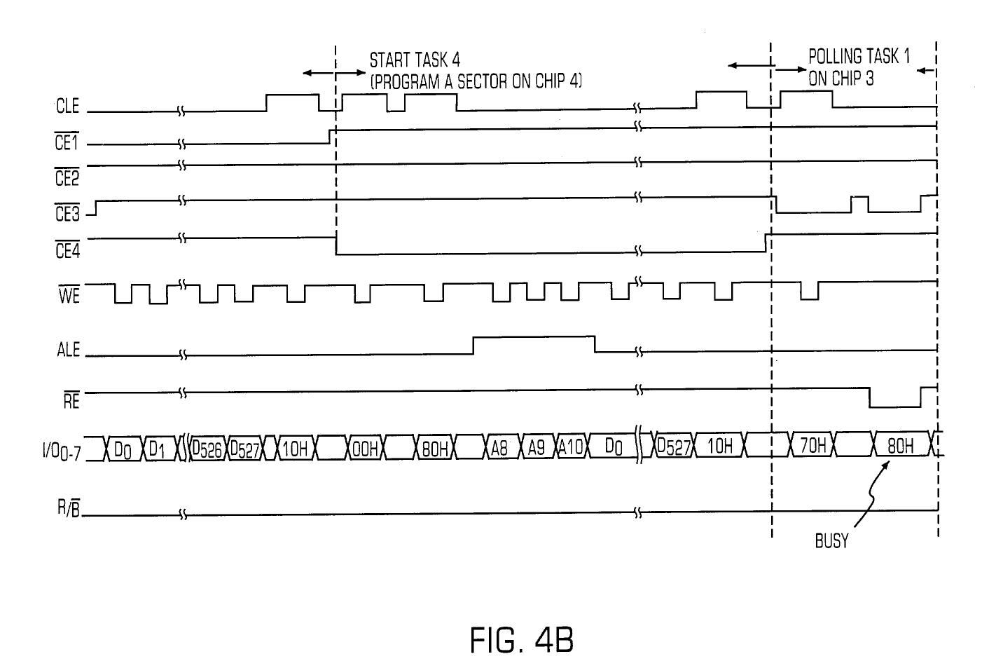

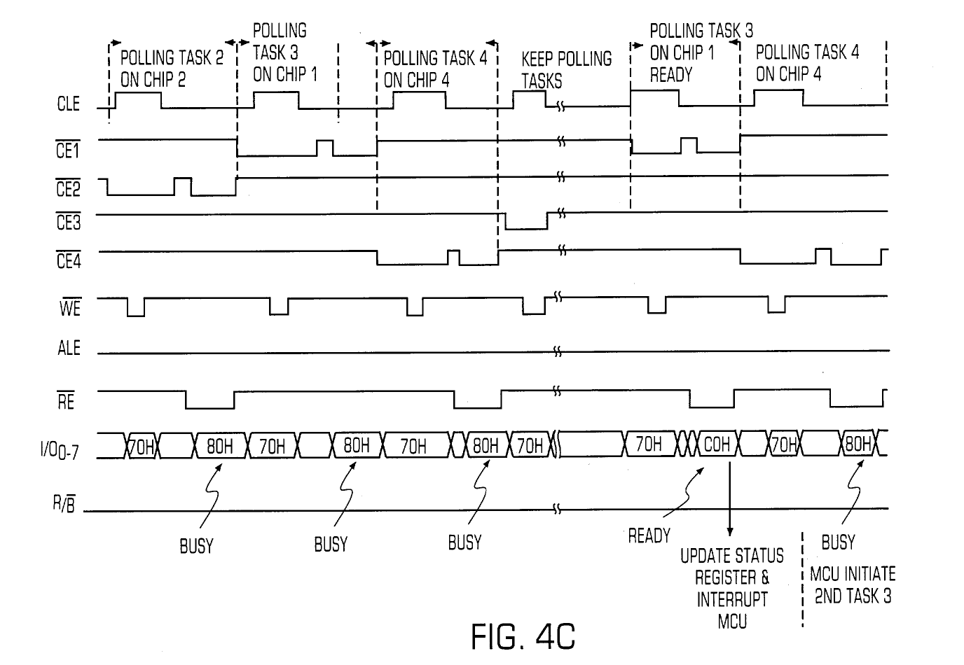

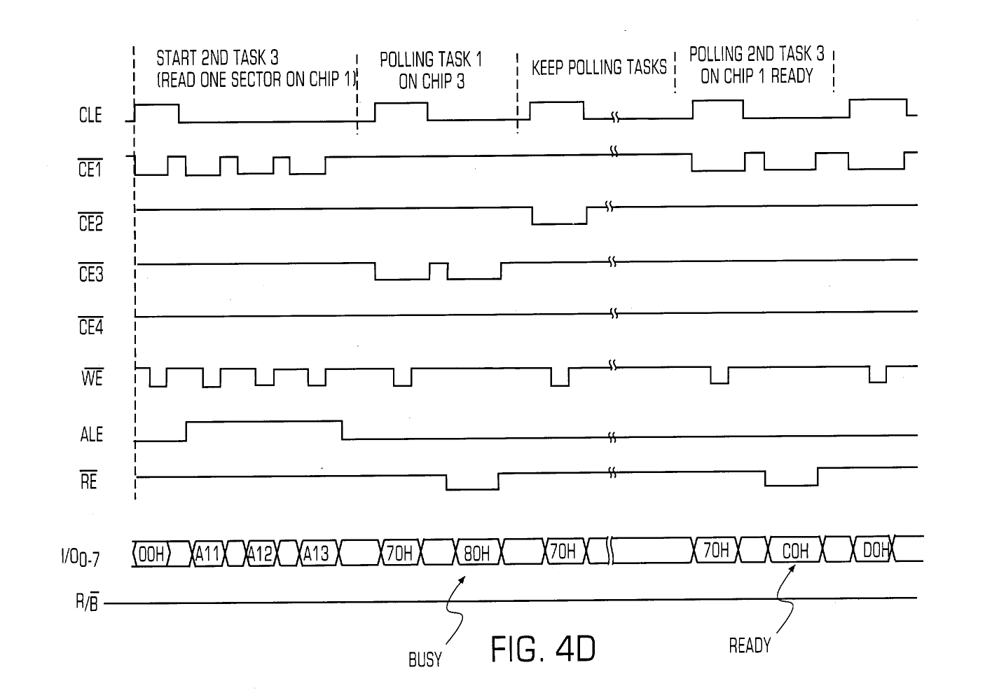

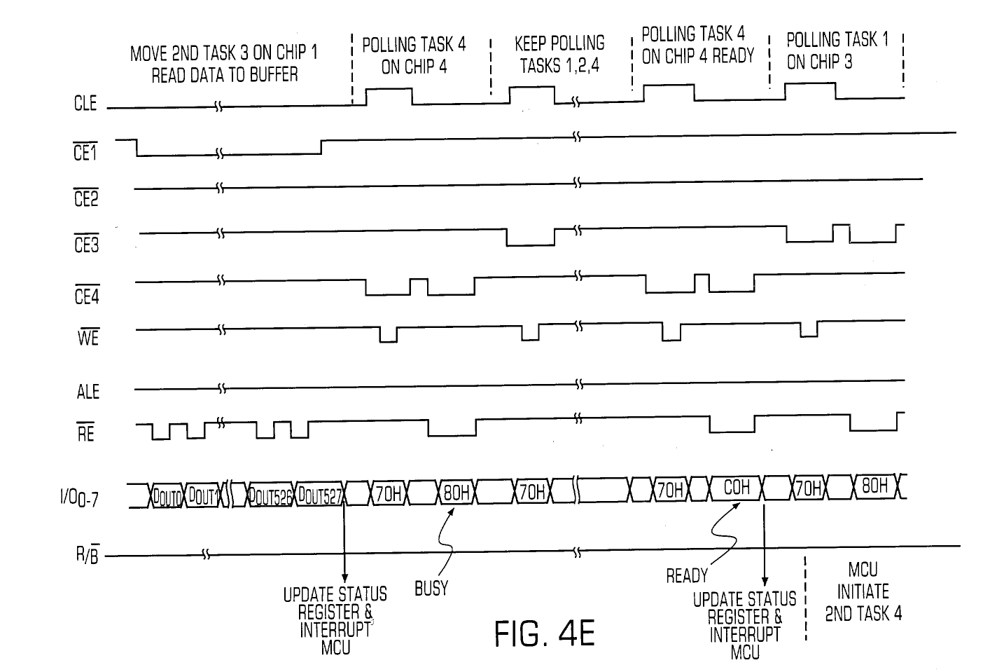

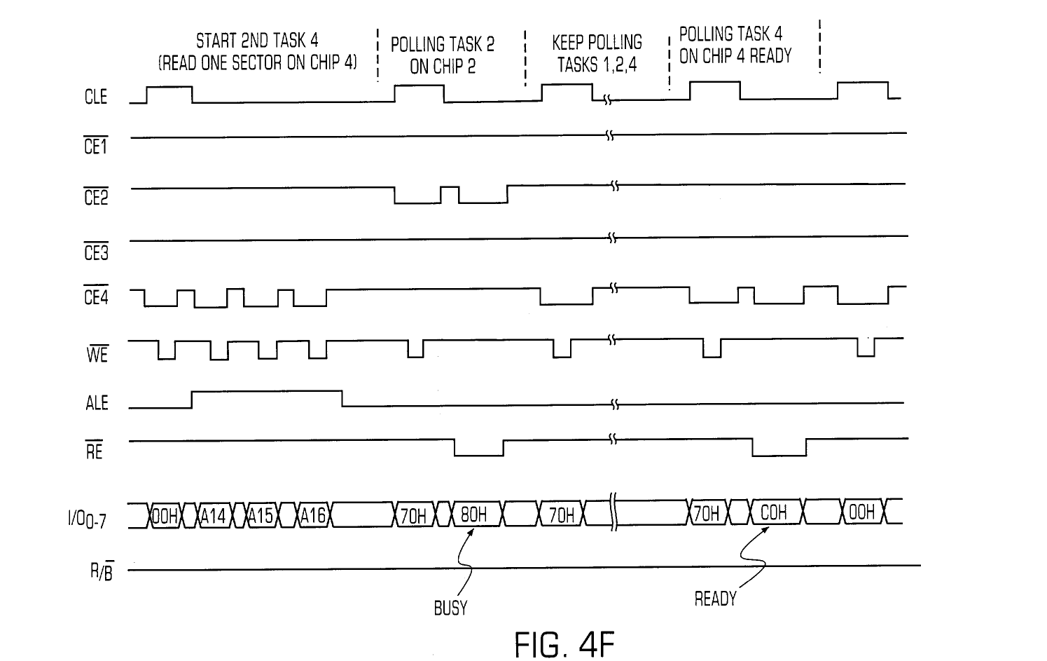

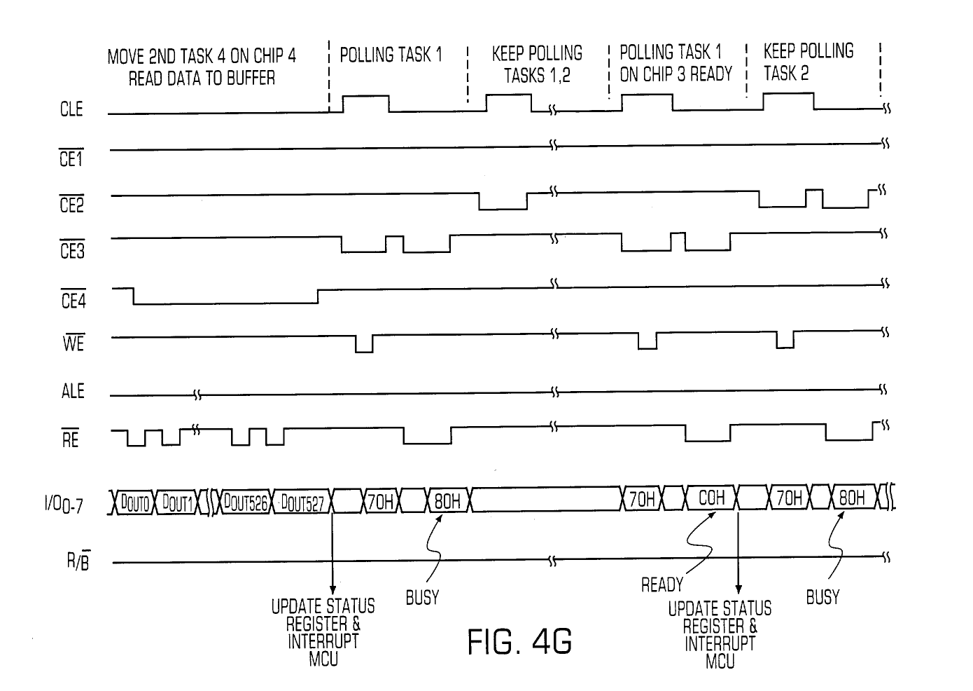

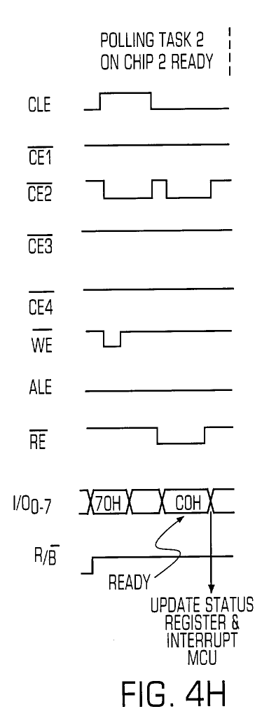

Referring to FIGS. 4A-4H, there is shown a timing chart of a multi-tasking operation involving two erase tasks and two program tasks with four integrated circuit memory chips 14 using the embodiment shown in FIG. 1. Initially, the MCU 22 writes to the task register sets 32 in accordance as follows:

Task 1 registers:

DSA_REG=3

CMD_REG=erase block

ADDR_REG=A1A2

SIZE_REG=1

BUFA_REG=1000

STATUS_REG=00

Task 2 registers:

DSA_REG=2

CMD_REG=erase block

ADDR_REG=A3A4

SIZE_REG=1

BUFA_REG=2000

STATUS_REG=00

Task 3 registers:

DSA_REG=1

CMD_REG=program sector

ADDR_REG=A5A6A7

SIZE_REG=1

BUFA_REG=3000

STATUS_REG=00

Task 4 registers:

DSA_REG=4

CMD_REG=program sector

ADDR_REG=A8A9A10

SIZE_REG=1

BUFA_REG=4000

STATUS_REG=00

The various signals shown in FIGS. 4A-4H are as follows: the signal CLE is Command Latch Enable. The signal CE1, CE2, CE3 and CE4 are the chip enable signals for each of the four separate integrated circuit memory chips 14. The signal WE bar is a write enable signal which is connected to the write enable pin of each of the independent integrated circuit memory chips 14. The signal ALE is Address Latch Enable. The signal RE bar is the read enable signal which is connected common to the read enable pin of each of the four independent integrated circuit memory chips 14. The I/O signals represents the common buses to which the integrated circuit memory chips 14 are connected. Finally, the signal R/B (bar) represents the signal ready/busy which is connected common to each of the four independent integrated circuit memory chips 14.

When the task scheduler 34 begins or starts task 1, the MCU 22 completes its set up of tasks 2, 3 and 4. After task 1 is started, the status polling scheduler 36 requests access to the media bus through the media bus arbitrator 38 for polling. However, in the meantime, the task scheduler 34 also requests access to the media bus to begin tasks 2, 3 and 4. Because the task scheduler 34 has a higher priority than the polling scheduler 36, the media bus arbitrator 38 grants access to the media bus to the task scheduler 34. Thus, tasks 2, 3 and 4 are then started by the task scheduler 34 one after another in a round robin algorithm. After the task 4 is started, the media bus arbitrator 38 grants access to the media bus to the polling scheduler 36. Polling then starts with tasks 1, 2, 3 and 4 in sequence, again in a round robin algorithm as an example. The polling scheduler 36 keeps polling the tasks, one after another, for some time. For example, when task 3 is completed, the multi-tasking media control 40 updates the task 3 registers in the task register sets 32 and interrupts the MCU 22. The polling scheduler 36 then moves on to poll the next task which is task 4. While the status polling scheduler 36 polls task 4, the MCU 22 sets up another task 3. The another task 3 with its associated registers in the task register sets 32 may be as follows:

Task 3 registers:

DSA_REG=1

CMD_REG=read sector

ADDR_REG=A11A12A13

SIZE_REG=1

BUFA_REG=3000

STATUS_REG=00

After polling task 4 by the status polling scheduler 36 (and assuming it is still being operated upon and therefore is busy) the task scheduler 34 gets access to the media bus from the media bus arbitrator 38 and begins the another task 3. This another task 3, as can be seen from the foregoing, is a read sector operation. After the another task 3 has commenced, the polling scheduler 36 then has access to the media bus through the media bus arbitrator 38 and resumes the round robin polling of tasks 1, 2, 3, and 4.

Assuming that the another task 3 is completed, the multi-tasking media control 40 will then move the read data from chip 1 (in DSA_REG) to the buffer 3000 in BUFA_REG which is located in the SRAM 26 and then updates the another task 3 status and interrupts the MCU 22. Polling then resumes from task 4 and continues with task 1, 2 and 4. Task 3 will be skipped by the polling scheduler 36 because there is no task 3 which is being executed.

Assuming that after a while, task 4 is completed, the multi-tasking media control block 40 will then update the task 4 status in the task register set 32 and interrupt the MCU 22. The polling scheduler 36 then resumes the polling of the tasks by checking tasks 1 and 2. At the same time, the MCU 22 sets up another task 4 with the registers having the values as follows:

Task 4 registers:

DSA_REG=4

CMD_REG=read sector

ADDR_REG=A14A15A16

SIZE_REG=1

BUFA_REG=4000

STATUS_REG=00

After polling task 1, the task scheduler 34 obtains access to the media bus through the media bus arbitrator 38 and starts the another task 4, which is a read sector operation. The polling schedule 36 then accesses the media bus and polling resumes from task 2 and continues with task 4 and then back to task 1, because there is no task 3 that is then currently pending. When the another task 4 is completed, the multi-tasking media control 40 will then move the data from integrated circuit memory chip 14 which is the fourth chip in DSA_REG to the buffer 4000 in BUFA_REG. It then updates task 4 status in the task register set 32 and interrupts the MCU 22. Polling then resumes from task 1 and continues to task 2. Since there is no tasks 3 or 4, those tasks will be skipped.

If after a period task 1 is completed, the multi-tasking media control will update task 1 status in the task register set 32 and interrupt the MCU 22. Then polling resumes only for task 2 because only task 2 is pending. Once the execution of task 2 is completed, the multi-tasking media control 40 updates task 2 status in the task register set 32 and interrupts the MCU 22. The controller 12 then remains idle. Clearly, the foregoing operation can be performed by the subsystem 110, except there may be simultaneous operation of the task scheduler 34 and status polling scheduler 36.

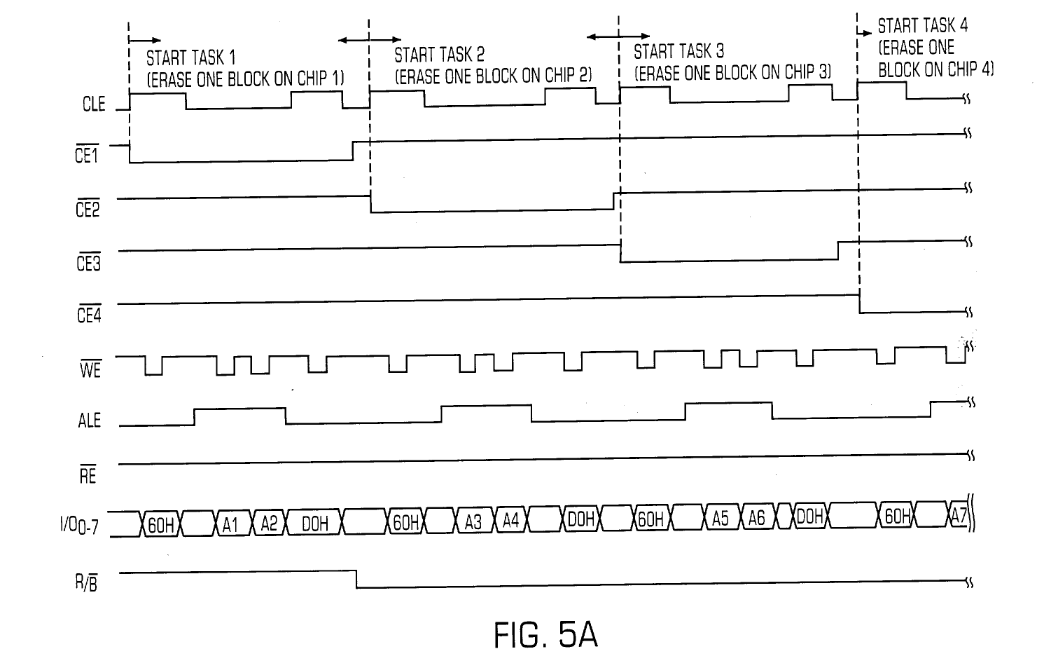

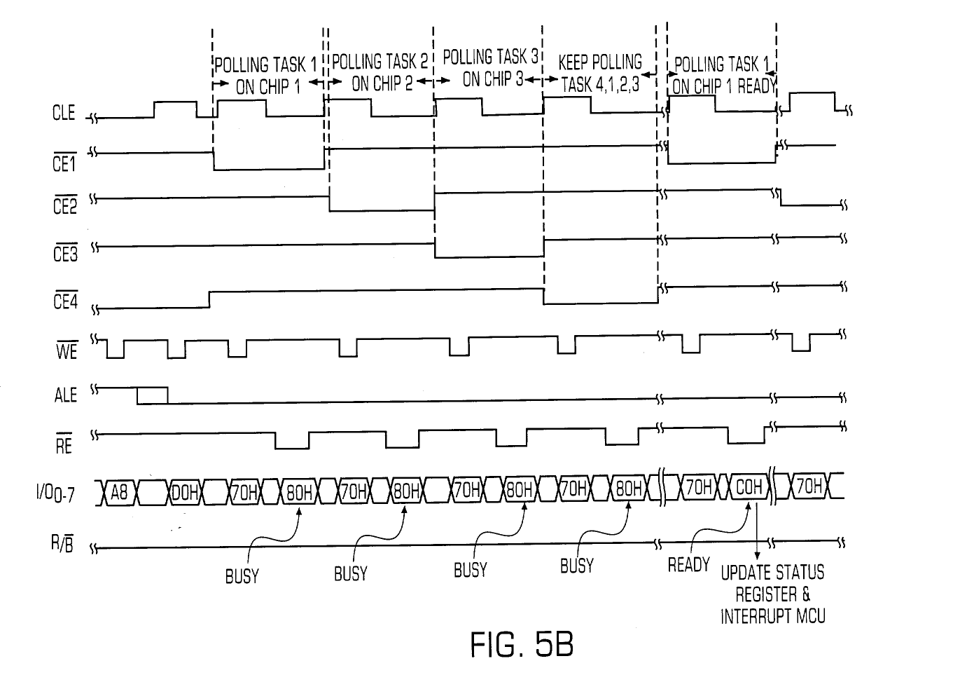

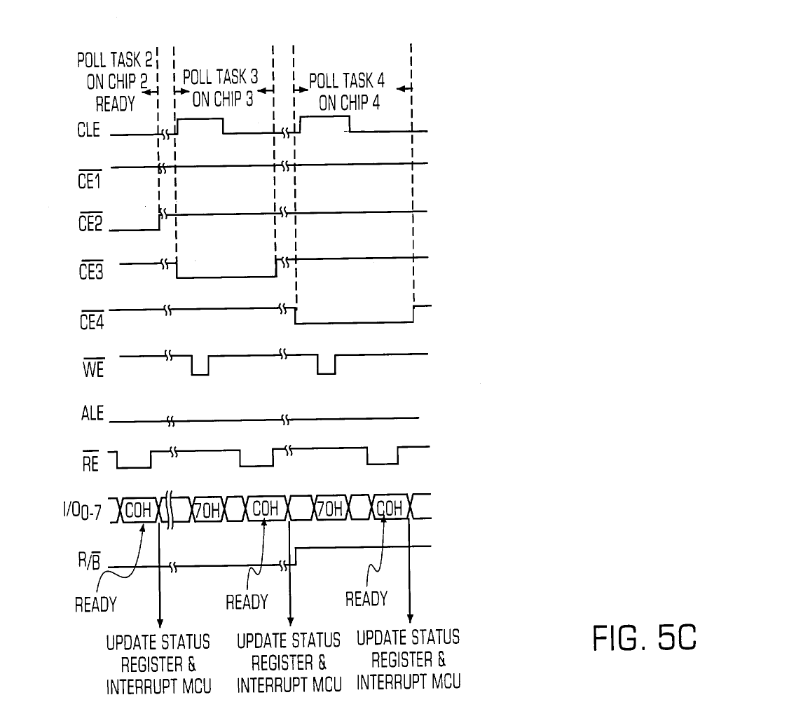

Referring to FIGS. 5A-5C, there is shown a timing diagram of the operation of the subsystem 10 shown in FIG. 1 for operation of four simultaneous tasks. The four tasks are erase tasks and they begin by the MCU 22 writing to the task registers 32 as follows:

Task 1 registers:

DSA_REG=1

CMD_REG=erase block

ADDR_REG=A1A3

SIZE_REG=1

BUFA_REG=1000

STATUS_REG=00

Task 2 registers:

DSA_REG=2

CMD_REG=erase block

ADDR_REG=A3A4

SIZE_REG=1

BUFA_REG=2000

STATUS_REG=00

Task 3 registers:

DSA_REG=3

CMD_REG=erase block

ADDR_REG=A5A6

SIZE_REG=1

BUFA_REG=3000

STATUS_REG=00

Task 4 registers:

DSA_REG=4

CMD_REG=erase block

ADDR_REG=A7A8

SIZE_REG=1

BUFA_REG=4000

STATUS_REG=00

Initially, the MCU 22 loads the task register sets 32 with the data for the start of task 1. Once the parameters for the registers for task 1 have been loaded into the task register set 32, the task scheduler 34 commences to start task 1. At the same time, the MCU 22 sets up the registers for tasks 2, 3 and 4. In addition, the polling scheduler 36 requests access to media bus for polling. However, since the task scheduler 34 also requests access to the media to start tasks 2, 3 and 4, and since it has higher priority of access to the media bus than the polling scheduler 36, the media bus arbitrator 38 grants the media bus access to the task scheduler 34. Therefore, the task polling scheduler 36 waits until tasks 2, 3 and 4 are started by the task scheduler 34. After task 4 has been started, the media bus arbitrator 38 then grants access to the media bus to the media bus scheduler 36. The status polling scheduler 36 begins polling the tasks 1, 2, 3 and 4 in an algorithm, such as the round robin algorithm. When one of the tasks is completed, e.g., task 1 is completed, the multi-tasking media control 40 will update the registers for task 1 in the task register set 32 and will interrupt the MCU 22. Polling continues until task 2 is completed. At that point, the multi-tasking media control 40 will update the registers for task 2 in the task register set 32 and interrupt the MCU 22. If no other tasks are commenced then polling continues onto tasks 3 and 4. Assuming task 3 is completed next, the multi-tasking media control 40 then updates the task 3 registers and interrupts the MCU 22. Finally, polling continues with task 4 until it is completed. At that point, the multi-tasking media control 40 will update the registers for task 4 and interrupt the MCU 22. Subsystem 10 then enters into an idle mode.

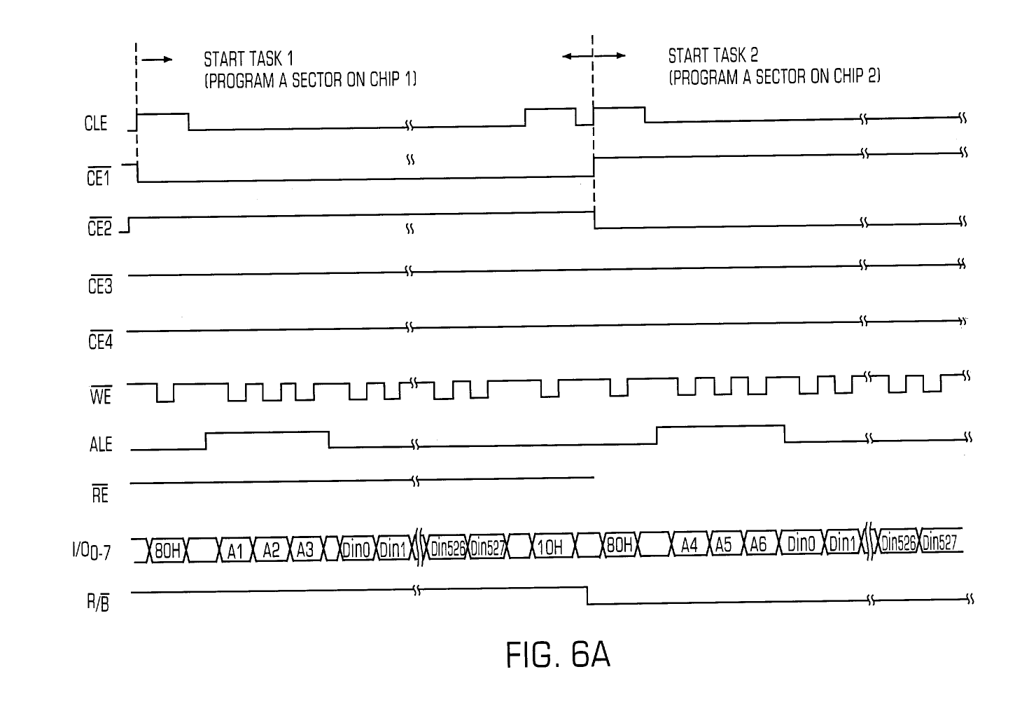

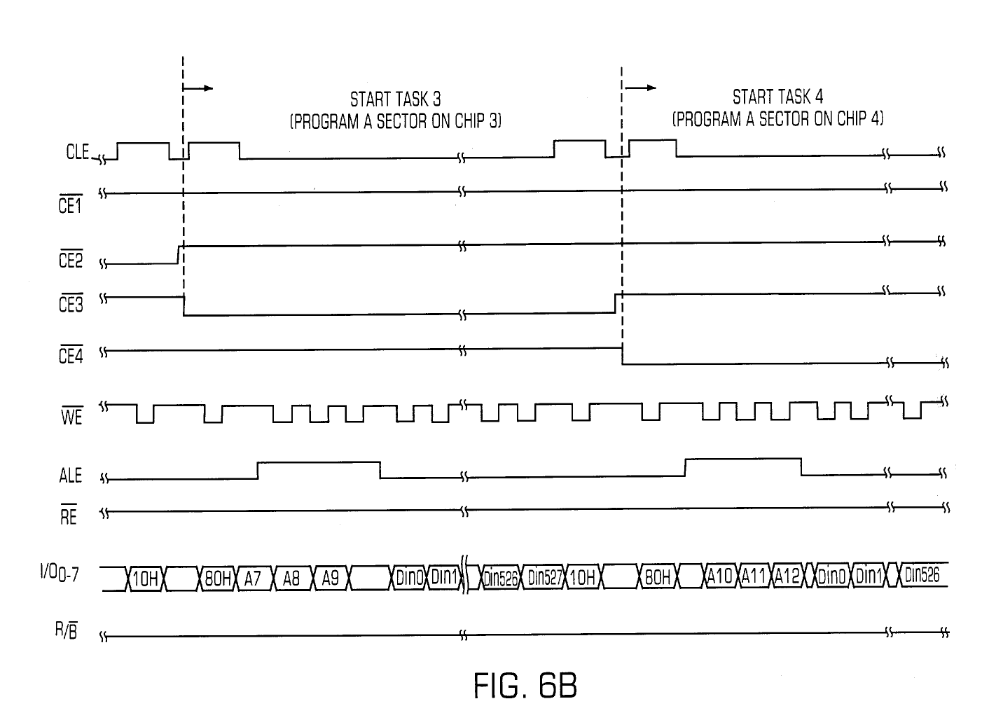

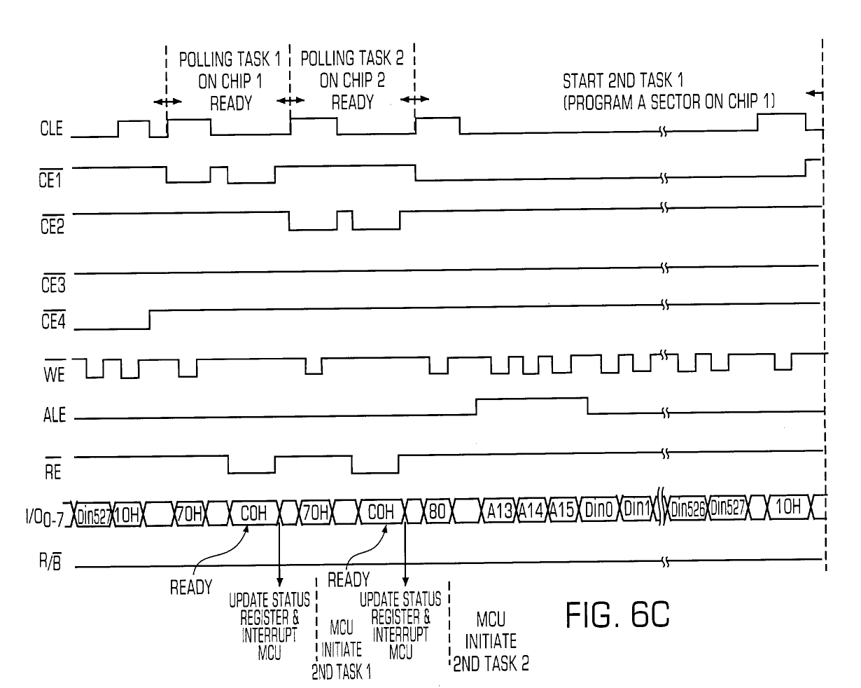

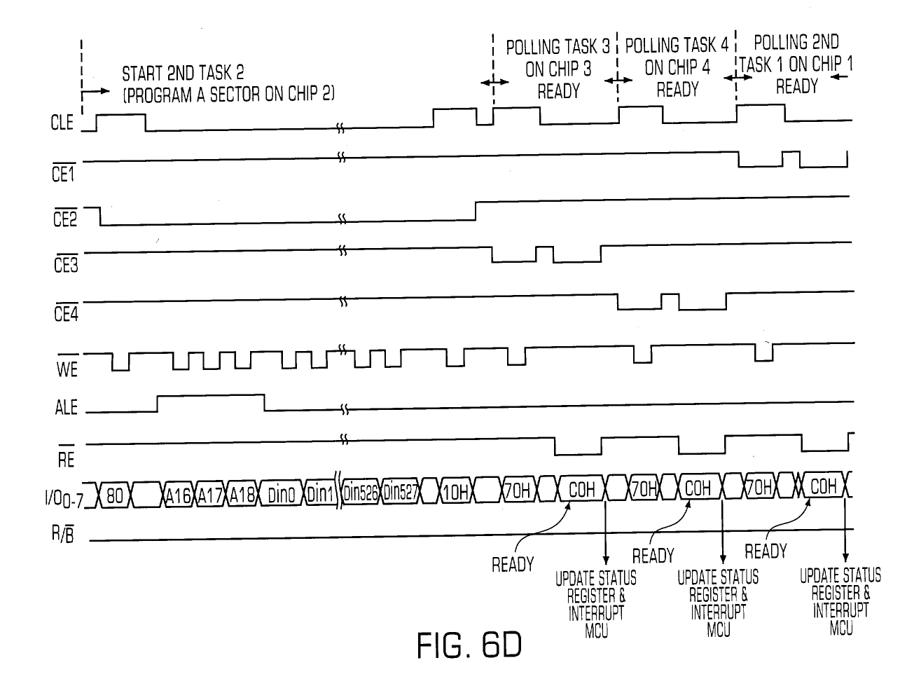

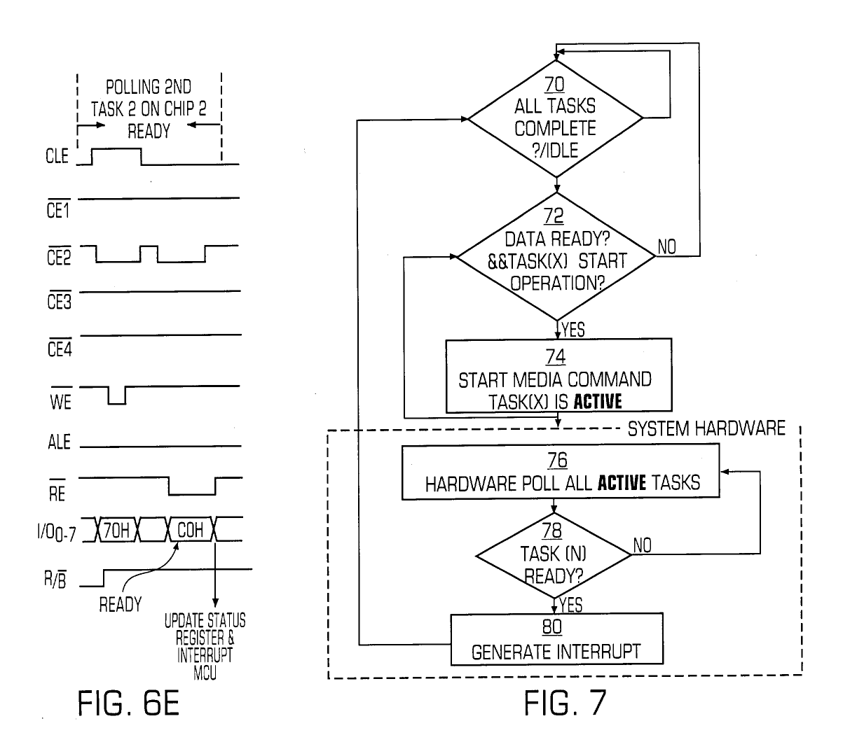

Referring to FIGS. 6A-6E, there is shown a timing diagram of the operation of the subsystem 10 operating with six program tasks simultaneously. Initially, the MCU 22 writes to the task register set 32 with the following register parameters.

Task 1 registers:

DSA_REG=1

CMD_REG=program sector

ADDR_REG=A1A2A3

SIZE_REG=1

BUFA_REG=1000

STATUS_REG=00

Task 2 registers:

DSA_REG=2

CMD_REG=program sector

ADDR_REG=A4A5A6

SIZE_REG=1

BUFA_REG=2000

STATUS_REG=00

Task 3 registers:

DSA_REG=3

CMD_REG=program sector

ADDR_REG=A7A8A9

SIZE_REG=1

BUFA_REG=3000

STATUS_REG=00

Task 4 registers:

DSA_REG=4

CMD_REG=program sector

ADDR_REG=A10A11A12

SIZE_REG=1

BUFA_REG=4000

STATUS_REG=00

Again, similar to the previous discussion, after the parameters for task 1 have been written into the task register set 32, the polling scheduler 34 requests access to the media bus for commencing task 1. At the same time, the MCU completes the set up of tasks 2, 3 and 4. In addition, the status polling scheduler 36 also requests access to the media bus. However, because the task scheduler 34 has a higher priority than the status polling scheduler 36, access to the media bus is granted to the task scheduler 34 by the media bus arbitrator 38. The tasks 2, 3 and 4 are then started by the task scheduler 34 in a round robin algorithm. After task 4 started, the media bus arbitrator 38 grants access to the media bus to the polling scheduler 36. The polling scheduler 36 starts from task 1 and polls it in a round robin algorithm to tasks 2, 3 and 4. When task 1 is completed, the multi-tasking media control 40 updates task status registers in the register set 32 and also interrupts the MCU 22. The status polling scheduler 36 then resumes the polling of tasks 2, 3 and 4.

In the meantime, the MCU 22 loads the task register set 32 with a second task 1 with parameters as follows:

Task 1 registers:

DSA_REG=1

CMD_REG=program sector

ADDR_REG=A13A14A15

SIZE_REG=1

BUFA_REG=1000

STATUS_REG=00

Assuming then that the next event to occur is the completion of task 2, the multi-tasking media control 40 will then update the registers for task 2 in the task register set 32 and interrupt the MCU 22. The task scheduler 34 will get higher priority to start the second task 1 than the polling scheduler 36 to poll task 3. Thus, the second task 1 is started. In the meantime, the MCU 22 commences to set up the second task 2 with the registers for the second task 2 having parameters as follows:

Task 2 registers:

DSA_REG=2

CMD_REG=program sector

ADDR_REG=A16A17A18

SIZE_REG=1

BUFA_REG=2000

STATUS_REG=00

After the second task 1 is started, the task scheduler will start the second task 2 because again the task scheduler 34 has higher priority in access to the media bus than the status polling scheduler 36. The multi-tasking media control 40 will update task 3 registers in the task register set 32 and interrupt the MCU 22 when task 3 is completed. Polling continues with tasks 4, 1 and 2 in a round robin fashion. When task 4 is completed, the multi-tasking media 40 updates the registers of task register set 32 with regard to task 4 and interrupts the MCU 22. Polling by the status polling scheduler 36 continues with tasks 1 and 2 until they are completed. When the second task 1 is completed, the multi-tasking media control 40 updates the registers for task 1 and interrupts the MCU 22. Finally, polling continues with the second task 2 by the status polling scheduler 36. When the second task 2 is completed, the multi-tasking media control 40 updates the registers associated with task 2 in the task register set 32 and interrupts the MCU 22. The control subsystem 10 then enters into an idle mode.

To optimize the simultaneous operation of a plurality of tasks, it is necessary that during the program, erase or read operation, the controller 12 or 112 should release the chip enable or CE pin of each of the integrated circuit/memory chips 14 when the particular flash memory chip 14 starts its busy cycle. The flash memory chip 14 used in the subsystem 10 or 110 must support de-assertion of the chip enable pin that won't terminate the started operation. The controller 10 or 110 then uses the same bus to start another operation on a different chip 14 until the desired number of chips are enabled for the operation.

During the busy cycle of each chip 14, the status polling scheduler 36 issues a command to each enabled operating chip 14 to check the status of the operation from one chip 14 to another chip 14. Each chip 14 will report its status once it is selected for status update by a report status command. When one flash chip 14 finishes its operation and becomes ready during polling of several configured chips 14, the status polling schedulers 36 and the multi-tasking media control 40 will interrupt the firmware 28 operating on the MCU 22 to inform the MCU 22 that the corresponding chip 14 has finished the operation of its assigned task. Since the duration of the busy cycle of each of the integrated circuit flash memory 14 is much greater than its data transfer time, the increased performance will be substantial with a plurality of the chips 14 sharing the busy time essentially at the same time by all or as many of the chips 14 operating at the same time as possible. This results in the simultaneous execution of multi-tasks across multichips 14 at substantially the same time.

Typically, as used in a subsystem 10 or 110, the host 16 issues its commands or tasks for access to the flash memory chips 14 by task commands based upon a Logic Block Number (LBN). The MCU 22 operating the firmware stored in a ROM 28 must convert that LBN to a Physical Group Number (PGN). When the host 16 requests programming or write execution of tasks to a particular location, the firmware 28 operating on the MCU 22 will map the host LBN to a PGN. After that, the write operation or the programming operation commences with a plurality of chips 14 for that physical group. At the end of the write operation, the firmware stored in the ROM 28 as executed by the MCU 22 will erase and/or reallocate the previous PGN if the LBN was already written before. The erase operation also is multi-tasked for multiple blocks on multiple chips. For a read operation, the firmware 28 will find the PGN for the host LBN and start reading from a plurality of integrated circuit memory chips 14 using the multi tasking scheme as described before.

The mapping of a PGN to a plurality (N) of the integrated circuit memory chips 14 is constructed during the initial configuration of the flash memory subsystem 10 or 110, depending upon the number of flash integrated memory chips 14 available and power consumption requirement. This number N will dictate the number of tasks per PGN and will be used to configure the flash memory subsystem during initialization. Although N cannot be greater than the number of flash memory integrated circuit chips available, it can be reduced to one depending upon the power requirements as described hereinafter. PGN always consists of N blocks on N different chips. Therefore, N blocks within a PGN can be multitasked. Consequently, each operating task will be on a different chip.

The first block of a PGN can be mapped to the Starting Chip Number and the Starting Chip Block Number by the following algorithm.

G=B/N

SCN=PGN/G

CBN=(PGN % G)*N

Where:

/ is the result of integer division operation

% is the integer remainder of a division operation

N=Number of Tasks

B=Block Per Chip

G=Group Per Chip

CBN=Starting Chip Block Number

SCN=Starting Chip Number

Once the Starting Chip Number and Starting Chip Block number are known, the next Block of the PGN will be on the next block of the next chip. See also the example below in Paragraph

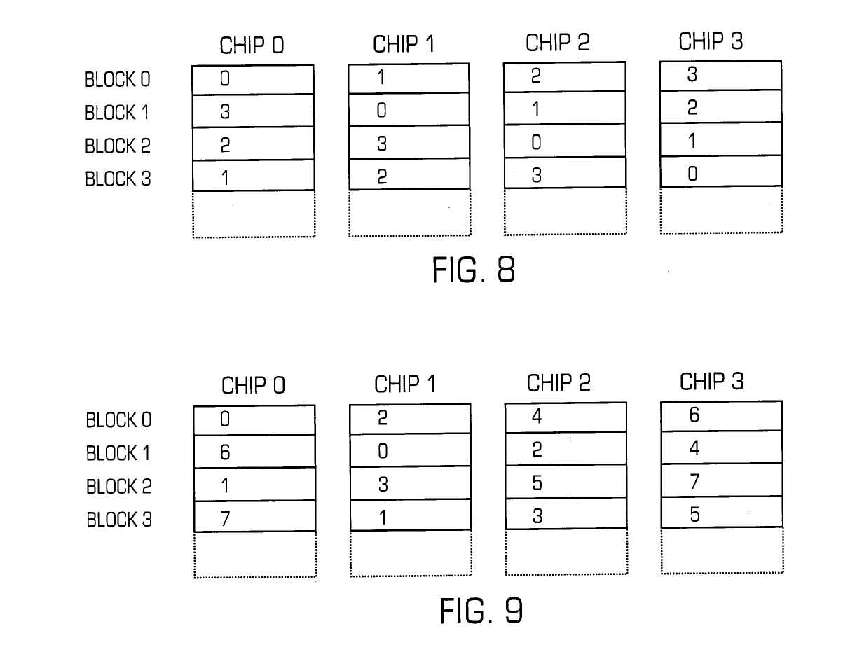

For example, in FIG. 8, the memory subsystem is configured to have 4 tasks, and there are 4 chips and each chip has 4 blocks, i.e., N=4, B=4, G=1. The SCN and CBN for PGN=0 can be calculated based upon the above algorithm as follows:

SCN=0/1=0

CBN=(0% 1)*4=0

The SCN and CBN for PGN=3 can be calculated based upon the above algorithm as follows:

SCN=3/1=3

CBN=(3% 1)*4=0

An example of the mapping of PGNs to a plurality of integrated circuit memory chips 14 or a grouping of PGNs to a plurality of blocks can be seen by reference to FIG. 8. In FIG. 8, four integrated circuit memory chips 14 (chips 0, 1, 2, 3) are grouped to perform four tasks. A first PGN (PGN=0) has four blocks which are mapped in the following order to block 0 of Chip 0, block 1 of Chip 1, block 2 of Chip 2, and block 3 of Chip 3. A second PGN (PGN=1) also has four blocks which are mapped in the following order to block 0 of Chip 1, block 1 of Chip 2, block 2 of Chip 3, and block 3 of Chip 0. A third PGN (PGN=2) has four blocks which are mapped in the following order to block 0 of Chip 2, block 1 of Chip 3, block 2 of Chip 0, and block 3 of Chip 1. Finally, a fourth PGN (PGN=3) has four blocks which are mapped in the following order to block 0 of Chip 3, block 1 of Chip 0, block 2 of Chip 1, and block 3 of Chip 2.

In operation, when task 1 involving the first PGN first block is started, only chip 0 is affected, since the first block of the first PGN is in Chip 0. At the same time, the start of task 2 using the second block will involve only chip 1, since the second block of the first PGN is in Chip 1. Similarly, the start of tasks 3 and 4 using the third and fourth blocks of the first PGN will affect chips 2 and 3. Therefore, the start of tasks 1-4 involving the first, second, third and fourth blocks of the first PGN can occur simultaneously.

A second example of the mapping of PGNs to a plurality of integrated circuit memory chips 14 can be seen by reference to FIG. 9. In FIG. 9, four integrated circuit memory chips (chips 0, 1, 2, 3) are grouped to perform two tasks. This may be due to current constraints of the subsystem 10 or 110 (discussed hereinafter). Each PGN has two blocks. A first PGN (PGN=0) is mapped to Chips 0 and 1 in the following order: block 0 of Chip 0 and block 1 of Chip 1. A second PGN (PGN=1) is mapped in the following order: block 2 of Chip 0 and block 3 of Chip 1. PGN=2 is mapped in the following order to block 0 of Chip 1 and block 1 of Chip 2. Finally, PGN=3 is mapped in the following order to block 2 of Chip 1 and block 3 of Chip 2. Similarly, PGN=4-7 are mapped to Chips 0, 1, 2 and 3 as shown in FIG. 9.

From the foregoing, it can be seen that each PGN maps to N chips. As shown in FIG. 8, PGN0 comprising of block 0 chip 0, block 1 chip 1, block 2 chip 2, and block 3 chip 3 can have four tasks executing on four different chips simultaneously. Each executing task will be handled by the hardware task scheduler 34 and status polling scheduler 36. Similarly, FIG. 9 shows block 2 chip 0 and block 3 chip 1 are allocated for PGN1 where both chip 0 and chip 1 can be activated as separate tasks on those assigned blocks.

As previously discussed, the number of chips 14 grouped to operate simultaneously may be less than the total number of chips 14 in the subsystem 10 or 110. This may be dictated by current requirements of the subsystem 10 or 110.

In the system 10 or 110 which is designed for use with various removable memory subsystem standards such as Compactflash, PCMCIA, Smart Media, Memory Stick, or ATA disk module, the amount of current available from host 16 can vary from one host 16 to another host 16. In order to use the subsystem 10 or 110 in a different host 16 with optimal performance, performance and current consumption need to be optimized.

Current consumption for the flash memory subsystem 10 or 110 will increase by the Number of Tasks. The numbers of Tasks (N) is initially preconfigured in firmware 28 and data structure. It cannot be changed after the subsystem 10 or 110 has been formatted. However, firmware 28 can control/reduce the active number of Tasks for power requirement of different host 16.

The present invention can optimize task scheduling (performance) vs. current consumption. The subsystem 10 or 110 is powered up in default in the lowest current consumption state, for example one task. If firmware 28 cannot establish communication with host 16, the default setting will be used for the subsystem 10 or 110 operation. If firmware 28 can communicate with host 16, then firmware 28 will decide how many tasks will be multi-tasking, i.e., how many chips 14 will be activated at the same time. By doing this, the maximum current and average current will be reduced to not to exceed the host spec. So the subsystem 10 or 110 optimizes performance under limited supply current from host 16 and can dynamically adjust the current base on the different host 16 requirement. This improves the subsystem 10 or 110 interoperability between different hosts 16. In addition, the number of tasks can be different based on the combination of memory operations. Some of operations may take more current than others. For example, under the same current limitation, four programming operations may take the same amount of current as two erase operations. Thus, there may be four simultaneous programming tasks, while there may be only two simultaneous erase tasks. In addition, the firmware can also adjust the duty cycle of various tasks to further optimize power vs. performance.

The firmware in ROM 28 effectively uses the blocks of a group to be distributed among a plurality of integrated circuit chips 14. FIG. 7 illustrates how the firmware 28 issues the commands to multiple chips 14 in a PGN. Each task [x] could be a read, write or erase operation on a different Flash media chip 14, x could be a number between {0, N−1 } where N is the number of tasks pre-configured by the system firmware 28. When a new task [x] is ready, firmware 28 will issue the media command to the system hardware. Media chip bus will be free as soon as Flash media chip 14 starts the operation and goes into busy cycle. Firmware 28 will continue issuing media commands until all media chips are activated as required for the PGN.

Any given time system hardware will poll all the active tasks and firmware 28 will know the command is complete for task [x] when the interrupt is generated for that task. Consequently, all media chips for the PGN will share the media busy cycle time and overall system performance will improve substantially.

An example of the mapping of PGN to four chips 14 arranged to operate simultaneously on four tasks is as follows.

Assume host 16 requests to write to LBN 1—with a count of 4.

Step 1: Find Physical Sectors. Firmware will map LBN 1 to PGN p according to system sector mapping information. SCN y and CBN s of group p can be calculated by the firmware as described above. Note that each host sector will be written to subsequent physical sectors inside the group p, and that these sectors will all be from different flash memory chips assured by the same grouping algorithm

Depending on how the sectors per blocks are arranged for the flash memory chip, actual physical group sectors will vary. The following physical sector numbers assume sectors per blocks is 20 h.

Following shows mapping of each sector to physical Chip y={0, 1, 2, 3} and physical sector s for Group p:

| | | Chip: | Physical Sector: |
|---|---|---|---|
| Group p Sector 0 | -> | y | s |
| Group p Sector 1 | -> | (y + 1)%4 | s + 20 h |
| Group p Sector 2 | -> | (y + 2)%4 | s + 40 h |
| Group p Sector 3 | -> | (y + 3)%4 | s + 60 h |

Step 2: Activate Hardware Taskx. In this example, since number of tasks is 4, x={0,1,2,3}:

Hardware Task Registers:

| | | |
|---|---|---|
| Taskx[DSA_REG] | <- | {y, (y + 1)%4, (y + 2)%4, (y + 3)%4} |
| Taskx[ADDR_REG] | <- | {s, s + 20 h, s + 40 h, s + 60 h} |
| Taskx[BUFA_REG] | <- | Bufferx |
| Taskx[SIZE_REG] | <- | 1 |
| Taskx[CMD_REG] | <- | program sector |

Starting from Task0 all tasks are activated. Taskx will be activated when the data from Host is ready in the Bufferx address.

Step 3: Wait for command completion interrupts. When interrupt for Taskx comes firmware will read hardware task register Taskx[STATUS_REG] for pass or fail of the program operation for the Flash memory chip x.

Step 4: Host write command will be reported as finished after all sectors for the corresponding tasks are programmed in the flash media chips.

What is claimed is:

1. A non-volatile memory subsystem comprising:
a plurality of non-volatile memory integrated circuit chips, each memory chip capable of being read, erased and programmed; each of said plurality of memory chips further having a data bus and an address bus; and
a controller chip coupled to said plurality of memory chips, and for receiving a plurality of externally supplied commands, said controller chip for converting said commands to a plurality of tasks to be executed by said plurality of memory chips, said controller further comprising:
a task scheduler for scheduling the simultaneous execution of said plurality of task by said plurality of memory chips; and
a status poll scheduler for polling each of said plurality of memory chips to determine when a memory chip has completed its task.

2. The subsystem of claim 1 wherein each of said plurality of memory chips is a NAND flash memory chip.

3. The subsystem of claim 1 wherein the number of tasks that can be executed simultaneously is alterable.

4. The subsystem of claim 3 wherein the number of tasks that can be executed simultaneously is alterable in response to current consumption or performance of said subsystem.

5. The subsystem of claim 1 wherein said data bus of said plurality of memory chips are commonly connected, and said address bus of said plurality of memory chips are commonly connected, with said address bus and said data bus being time multiplexed, and said controller chip further comprising
a bus arbitrator for arbitrating access to said commonly connected data bus and said commonly connected address bus by said task scheduler and by said status poll scheduler.

6. The subsystem of claim 5 wherein said controller chip further comprises:
a task register for storing said plurality of externally supplied tasks;
said task register coupled to said task scheduler and to said status poll scheduler;
a microcontroller for receiving said plurality of tasks and for storing said tasks in said register.

7. The subsystem of claim 6 further comprising:
a volatile memory for storing data read from said plurality of memory chips or written to said plurality of memory chips.

8. The subsystem of claim 6 wherein the number of tasks that can be executed simultaneously is alterable by said microcontroller.

9. The subsystem of claim 8 wherein said microcontroller alters the number of tasks that can be executed simultaneously in response to current consumption of said subsystem.

10. The subsystem of claim 6 wherein each of said plurality of memory chips has a plurality of sectors, and said controller chip receives an externally supplied logic block number (LBN) and maps said LBN to a Physical Group Number (PGN); wherein said PGN comprises a plurality of sectors mapped to a plurality of memory chips.

11. The subsystem of claim 10 wherein said controller chip maps a different section of said PGN to a different memory chip.

12. The subsystem of claim 11 wherein said controller chip maps a plurality of different LBN to a plurality of different PGN, with each block of PGN being mapped to a block of a different memory chip.

13. The subsystem of claim 1 wherein said data bus of said plurality of memory chips are not commonly connected, and said address bus of said plurality of memory chips are not commonly connected.

14. The subsystem of claim 13 wherein said controller chip further comprises:
a task register for storing said plurality of externally supplied tasks;
said task register coupled to said task scheduler and to said status poll scheduler;
a microcontroller for receiving said plurality of tasks and for storing said tasks in said register.

15. The subsystem of claim 14 further comprising:
a volatile memory for storing data read from said plurality of memory chips or written to said plurality of memory chips.

16. The subsystem of claim 14 wherein the number of tasks that can be executed simultaneously is alterable by said microcontroller.

17. The subsystem of claim 16 wherein said microcontroller alters the number of tasks that can be executed simultaneously in response to current consumption of said subsystem.

18. The subsystem of claim 17 wherein each of said plurality of memory chips has a plurality of sectors, and said controller chip receives an externally supplied logic block number (LBN) and maps said LBN to a Physical Group Number (PGN); wherein said PGN comprises a plurality of sectors mapped to a plurality of memory chips.

19. The subsystem of claim 18 wherein said controller chip maps a different section of said PGN to a different memory chip.

20. The subsystem of claim 19 wherein said controller chip maps a plurality of different LBN to a plurality of different PGN, with each block of PGN being mapped to a block of a different memory chip.

21. A flash memory subsystem for connection to a host and for receiving a plurality of commands, said commands include reading from, writing to, and erasing said subsystem, said subsystem comprising:
a plurality of flash memory integrated circuit chips, each memory chip capable of being read, erased and programmed; each of said plurality of memory chips further having a data bus and an address bus; and
a controller integrated circuit chip coupled to said plurality of memory chips, and for receiving the plurality of commands and for converting said commands to a plurality of tasks to be executed by said plurality of memory chips, said controller chip further comprising:
a task scheduler for scheduling the simultaneous execution of the plurality of tasks by said plurality of memory chips; and
a status poll scheduler for polling each of said plurality of memory chips to determine when a memory chip has completed its task.

22. A method of operating a plurality of tasks, substantially simultaneously, by a flash memory subsystem having a plurality of flash memory integrated circuit chips, said method comprising:
receiving a plurality of tasks, wherein each task is an operation on a Logical Block Number (LBN);
mapping each LBN to a Physical Group Number (PGN) wherein each PGN is a plurality of blocks in a plurality of different flash memory integrated circuit chips;
executing a plurality of operations on said plurality of blocks in said plurality of different flash memory integrated circuit chips wherein each of said plurality of blocks of a task is associated with a PGN.

23. The method of claim 22 wherein each of said plurality of flash memory integrated circuit chips has a data bus, and an address bus, with each chip capable of being read, erased, and programmed.

24. The method of claim 23 wherein said data bus of said memory chips are commonly connected, and wherein said address bus of said memory chips are commonly connected.

25. The method of claim 22 wherein each of said plurality of blocks of a task is associated with a different PGN.

26. The method of claim 22 wherein each of said plurality of blocks of a task is associated with the same PGN.
